(19) United States
(12) Patent Application Publication
(10) Pub. No.: US 2025/0368336 A1
(43) Pub. Date: Dec. 4, 2025

(54) AIRCRAFT PASSENGER SEAT AND HEADREST

(71) Applicant: Textron Innovations Inc., Providence, RI (US)

(72) Inventors: Cameron Boudreau, Farmers Branch, TX (US); Andrew Zahasky, North Richland Hills, TX (US); Chirag Patel, Flower Mound, TX (US); Craig Cillessen, Dallas, TX (US); Jonathan Andres, Mansfield, TX (US)

(73) Assignee: Textron Innovations Inc., Providence, RI (US)

(21) Appl. No.: 18/678,354

(22) Filed: May 30, 2024

(51) Int. Cl. B64D 11/06

(52) U.S. Cl. CPC B64D 11/0647; B64D 11/0627; B64D 11/0642

(57) ABSTRACT

A seat assembly for a vehicle includes a seat portion comprising a seat back including a first layer comprising a first foam material having a first density; a second layer on the first layer and comprising a second foam material having a second density less than the first density; and a third layer on the second layer and comprising a third foam material having a third density less than the second density. The seat portion further comprises a seat base including a fourth layer comprising a fourth foam material having a fourth density; a fifth layer on the fourth layer and comprising a fifth foam material having a fifth density less than the fourth density; and a sixth layer on the fifth layer and comprising a sixth foam material having a sixth density less than the fifth density. A headrest configured to stow a headset is also provided.

### TECHNICAL FIELD

This disclosure relates in general to the field of aircraft and, more particularly, though not exclusively, to a passenger seat and headrest for such aircraft.

### BACKGROUND

Certain rotorcraft, such as helicopters, may include one or more rotor systems. On example of a rotorcraft rotor system is a main rotor system. A main rotor system may generate aerodynamic lift to support the weight of the rotorcraft in flight and thrust to counteract aerodynamic drag and more the aircraft in forward flight. Another example of a rotorcraft rotor system is a tail rotor system. A tail rotor system may provide anti-torque and/or directional control for the rotorcraft.

### BRIEF DESCRIPTION OF THE DRAWINGS

To provide a more complete understanding of the present disclosure and features and advantages thereof, reference is made to the following description, taken in conjunction with the accompanying figures, in which like reference numerals represent like elements:

FIGS. 1A-1B illustrate an example rotorcraft in which embodiments described herein may be implemented;

FIG. 2 illustrates an example passenger seat and headrest assembly for a rotorcraft, such as the rotorcraft of FIGS. 1A-1B, according to features of embodiments described herein;

FIG. 3 illustrates a representative side cutaway view of the seat portion of the example passenger seat and headrest assembly of FIG. 2 showing example relative thicknesses of layers thereof according to features of embodiments described herein; and

FIG. 4 illustrates a perspective view of the rear of the head portion of the example passenger seat and headrest assembly of FIG. 2.

### DETAILED DESCRIPTION

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Additionally, as referred to herein in this specification, the terms “forward,” “aft,” “inboard,” and “outboard” may be used to describe relative relationship(s) between components and/or spatial orientation of aspect(s) of a component or components. The term “forward” may refer to a spatial direction that is closer to a front of an aircraft relative to another component or component aspect(s). The term “aft” may refer to a spatial direction that is closer to a rear of an aircraft relative to another component or component aspect(s). The term “inboard” may refer to a location of a component that is within the fuselage of an aircraft and/or a spatial direction that is closer to or along a centerline of the aircraft (wherein the centerline runs between the front and the rear of the aircraft) or other point of reference relative to another component or component aspect. The term “outboard” may refer to a location of a component that is outside the fuselage of an aircraft and/or a spatial direction that farther from the centerline of the aircraft or other point of reference relative to another component or component aspect.

Further, the present disclosure may repeat reference numerals and/or letters in the various examples. This repetition is for the purpose of simplicity and clarity and does not in itself dictate a relationship between the various embodiments and/or configurations discussed. Example embodiments that may be used to implement the features and functionality of this disclosure will now be described with more particular reference to the accompanying figures.

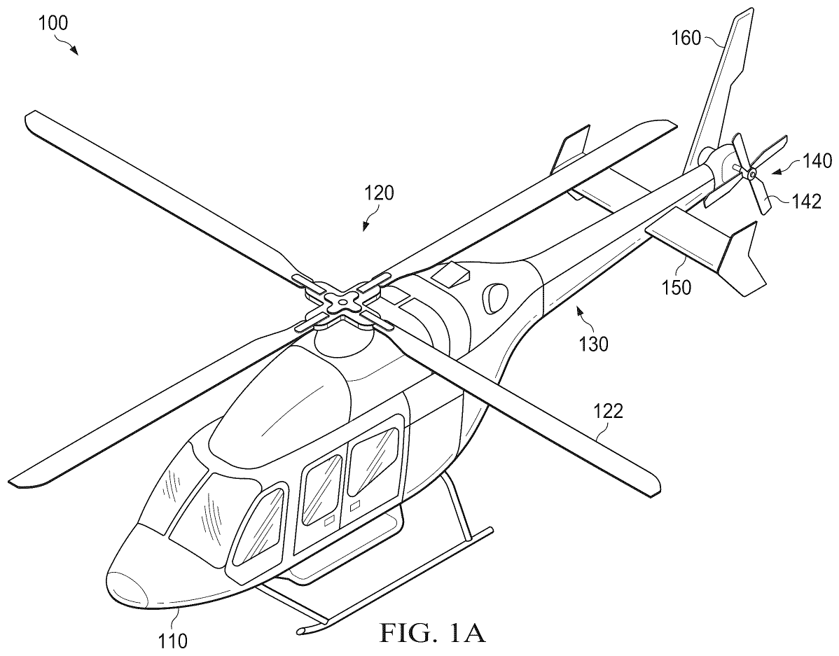

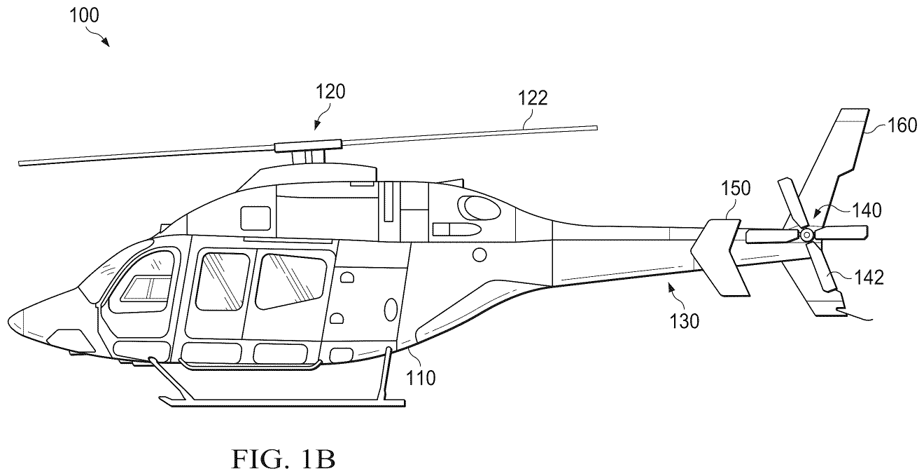

FIGS. 1A-1B illustrate various views of an example embodiment of a rotorcraft 100. Rotorcraft 100 includes a fuselage 110, a rotor system (also alternatively referred to as a main rotor system) 120, and an empennage 130. The fuselage 110 is the main body of the rotorcraft, which may include a cabin for the crew, passengers, and/or cargo, and may also house certain mechanical and electrical components, such as one or more engines, transmission systems, and flight controls. The rotor system 120 is used to generate lift for the rotorcraft using a plurality of rotating rotor blades 122. For example, torque generated by the engine(s) causes the rotor blades 122 to rotate, which in turn generates lift. Moreover, the pitch of each rotor blade 122 can be adjusted to selectively control direction, thrust, and lift for the rotorcraft 100. The empennage 130 is the tail assembly of the rotorcraft. In the illustrated embodiment, the empennage 130 includes a tail rotor system 140, which may be used to provide anti-torque and/or directional control for the rotorcraft 100 using a plurality of rotating rotor blades 142. For example, torque generated by the engine(s) causes the rotor blades 142 to rotate, which in turn provides anti-torque and/or directional control. Blades 142 may provide thrust in the same direction as the rotation of blades 122 to counter the torque effect created by rotor system 120 and blades 122. Teachings of certain embodiments recognize that blades 142 may represent one example of a secondary rotor system. Other examples may include, but are not limited to, forward-thrust propellers (e.g., pusher propellers, tractor propellers, etc.), tail anti-torque propellers, ducted rotors, and ducted and mounted inside and/or outside the rotorcraft 100.

In the illustrated embodiment, the empennage 130 also includes a horizontal stabilizer 150 and a vertical stabilizer 160. In general, a stabilizer is an aerodynamic surface or airfoil that produces an aerodynamic lifting force (either positive or negative). For example, a stabilizer may be a fixed or adjustable structure with an airfoil shape and may also include one or more movable control surfaces. The primary purpose of a stabilizer is to improve stability about a particular axis (e.g., pitch or yaw stability), although a stabilizer can also provide other secondary aerodynamic benefits.

A horizontal stabilizer (e.g., horizontal stabilizer 150) is primarily used to provide stability in pitch, or longitudinal stability. For example, both the rotor and fuselage of a rotorcraft typically have an inherent negative stability derivative in pitch, and accordingly, a horizontal stabilizer may be used to neutralize pitch instability and improve the overall handling qualities of the rotorcraft. A horizontal stabilizer may also be used to generate lift for a rotorcraft, for example, to aid in climb or ascent. In some cases, a horizontal stabilizer may also include one or more movable control surfaces, such as an adjustable slat to aid in generating lift. The design of a horizontal stabilizer (e.g., airfoil shape, size, position on a rotorcraft, control surfaces) implicates numerous performance considerations and is often an extremely challenging aspect of aircraft design.

A vertical stabilizer (e.g., vertical stabilizer 160) is primarily used to provide stability in yaw, or directional stability. Although considerable yaw stability and control is often provided by a tail rotor, a vertical stabilizer may be used to supplement the performance of the tail rotor and/or reduce the performance requirements of the tail rotor. Accordingly, designing a vertical stabilizer and a tail rotor often implicates numerous interrelated performance considerations, particularly due to the interaction between their respective airflows. For example, a smaller vertical stabilizer may reduce the adverse effects on tail rotor efficiency but may adversely impact yaw stability and other design requirements (e.g., sideward flight performance, internal capacity for housing components within the vertical stabilizer). Accordingly, various performance considerations must be carefully balanced when designing a vertical stabilizer.

It will be recognized that various embodiments of horizontal and vertical stabilizers with designs that balance a variety of performance considerations to provide optimal performance may be provided. For example, certain embodiments of a horizontal stabilizer may be designed to provide strong aerodynamic performance (e.g., pitch stability and/or generating sufficient lift during climb or ascent) without using slats. Such a horizontal stabilizer may use a tailored airfoil design that is cambered and may form a concave slope on the top surface and/or a convex slope on the bottom surface. In some embodiments, the horizontal stabilizer may be mounted on the aft end of a rotorcraft. By obviating the need for slats, such a horizontal stabilizer design reduces complexity without a performance penalty, thus resulting in a more cost-efficient and reliable solution. Moreover, eliminating the slats similarly eliminates the need to provide anti-icing for the slats, thus providing a further reduction in complexity.

Moreover, certain embodiments of a vertical stabilizer may be designed to provide strong aerodynamic performance. Such a vertical stabilizer may use a tailored airfoil design that satisfies various design criteria, including strong aerodynamic performance (e.g., yaw stability, anti-torque control, minimal flow separation and drag). In some embodiments, for example, the vertical stabilizer may have a cambered airfoil shape that provides the requisite yaw stability and anti-torque control while also minimizing flow separation and drag. The cambered airfoil shape, for example, may enable the vertical stabilizer to provide a portion of the anti-torque required in forward flight (e.g., reducing the anti-torque requirements and power consumption of the tail rotor), and/or may also provide sufficient anti-torque to allow continued flight in the event of a tail rotor failure. The cambered airfoil shape may also enable the vertical stabilizer to provide sufficient aerodynamic side-force to offset the tail rotor thrust in forward flight, thus minimizing tail rotor flapping and cyclic loads and maximizing the fatigue life of components. Moreover, in some embodiments, the vertical stabilizer may have a blunt trailing edge (rather than a pointed trailing edge) to reduce the thickness tapering on the aft end without modifying the desired chord length, thus minimizing flow separation and drag while also reducing manufacturing complexity.

It should be appreciated that rotorcraft 100 illustrated in FIGS. 1A and 1B is merely illustrative of a variety of aircraft in connection with which the embodiments described throughout this disclosure may be implemented. Other such aircraft may include, for example, fixed wing airplanes, hybrid aircraft, tiltrotor aircraft, unmanned aircraft, gyrocopters, a variety of helicopter configurations, and drones, among other examples.

Teachings of certain embodiments relating to rotor systems described herein may apply to rotor system 120 and/or other rotor systems, such as tiltrotor and helicopter rotor systems. It should be appreciated that teachings from rotorcraft 100 may apply to aircraft other than rotorcraft, such as airplanes, to name another example. In some embodiments, rotorcraft 100 may include a variety of additional components not shown in FIGS. 1A and 1B. For example, rotor system 120 may include components such as a power train, drive shafts, a hub, a swatch plate, and pitch links.

The components of rotor assemblies described herein may comprise any materials suitable for use with an aircraft rotor. For example, rotor blades and other components may comprise carbon fiber, fiberglass, or aluminum; and rotor masts and other components may comprise steel or titanium.

Current rotorcraft passenger seats are not typically designed with the comfort of the passenger in mind. Such seats may not provide thigh, lower back lateral, or lower back lumbar support. The headrests of such seats are typically flat and are devoid of contours designed to support and cradle the head of the passenger. Previous attempts to provide lumbar support include using inflatable bladders or mechanically operated mechanisms, which can fail over time.

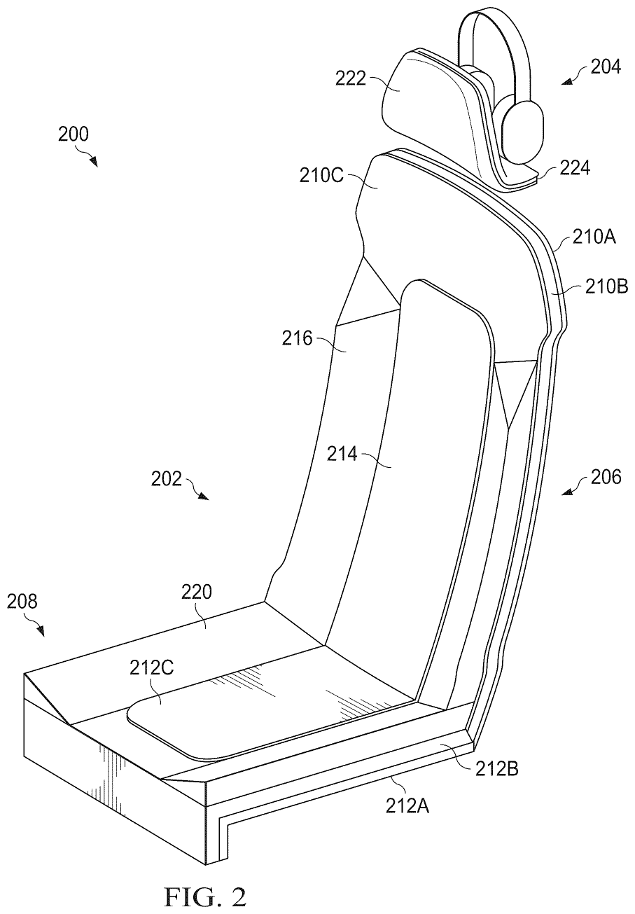

Referring now to FIG. 2, in accordance with features of embodiments described herein, a seat and headrest assembly 200 for use in aircraft (particularly rotorcraft) may be ergonomically designed to provide aesthetic enhancements to passenger comfort and useability. As shown in FIG. 2, assembly 200 includes a seat portion 202 and a headrest portion 204. Seat portion 202 includes a seat back 206 and a seat base 208. In one embodiment, seat back 206 includes a back layer 210A, a middle layer 210B, and a front layer 210C, each of which comprises a foam material having a density (or firmness) different than that of the other two layers. For example, back layer 210A may comprise a foam material having a density, or firmness, that is 15-20% greater than that of middle layer 210B. Middle layer 210B may comprise a foam material having a density, or firmness, that is 15-20% greater than that of front layer 210C. For the sake of simplicity, the material comprising back layer 210A may be referred to herein as “high density foam,” the material comprising middle layer 210B may be referred to herein as “medium density foam,” and the material comprising the front layer 210C may be referred to herein as “low density foam.” In particular embodiments, high density foam may be defined as foam having a density in the range of 60-70 kg/m³, medium density foam may be defined as foam having a density in the range of 50-60 kg/m³, and low density foam may be defined as foam having a density in the range of 40-50 kg/m³, for example.

Seat base 208 comprises a bottom layer 212A and a top layer 212B each comprising foam materials having different densities. In a particular embodiment, bottom layer 212A comprises high density foam similar to that used to implement back layer 210A. Top layer 212B comprises medium density foam such as that used to implement middle layer 210B. In some embodiments, the back layer 210A and bottom layer 212A may be fabricated from a single piece of high density foam. Similarly, in some embodiments middle layer 210B and top layer 212B may be fabricated from a single piece of medium density foam. In alternative embodiments, the foam material used to implement back layer 210A and bottom layer 212A may have slightly different densities, or firmnesses. Similarly, in alternative embodiments, the foam material from which middle layer 210B and top layer 212B are constructed may have slightly different densities, or firmnesses. As with seat back 206, the foam material comprising bottom layer 212A may have a density, or firmness, that is 15-20% greater than that of middle layer 212B.

In particular embodiments, seat base 208 includes a comfort layer 212C which may be disposed in a center portion of seat base 208 on top of top layer 212B to provide additional cushioning for the buttocks and back of thighs of a passenger. Comfort layer 212C may comprise low density foam material identical to that used to implement front layer 210C. In alternative embodiments, the foam material from which front layer 210C and comfort layer 212C are constructed may have slightly different densities, or firmnesses. The foam material comprising top layer 212B may have a density, or firmness, that is 15-20% greater than that of comfort layer 212C.

Seat back 206 may comprise a lumbar support area 214 for supporting a back of a passenger. In some embodiments, lumbar support area 214 may comprise a center portion of front layer 210C. A thickness of lumbar support area 214 may be the same as that of the remainder of front layer 210C; alternatively, the thickness of lumbar support area may be greater than that of the remainder of front layer. In alternative embodiments, the foam material from which front layer 210C and lumbar support area 214 are constructed may have slightly different densities, or firmnesses.

In the illustrated embodiment, lumbar support area 214 extends substantially vertically from the bottom of seat back 206 up to near the top of seat back. Lumbar support area 214 further extends laterally between lateral support bolsters 216 provided on opposite sides of seat back 206. Lateral support bolsters 216 may comprise low density foam material identical to that used to implement front layer 210C. In alternative embodiments, the foam material from which front layer 210C and lateral support bolsters 216 are constructed may have slightly different densities, or firmnesses. In particular embodiments, lateral support bolsters 216 are configured to extend from the bottom of seat back to seated shoulder height of an average passenger. As illustrated in FIG. 2, a thickness of lateral support bolsters 216 tapers from a maximum thickness at the outer edges of seat back 206 to a minimum thickness (approximately the thickness of lumbar support area 214) at the lumbar support area. In particular embodiments, lateral support bolsters 216 and lumbar support 214 interoperate to functionally cradle a passenger seated in seat portion 202.

In the illustrated embodiment, comfort layer 212C extends from the rear of seat base 208 toward front edge of seat base. Comfort layer 212C may extend all the way to front edge of seat base 208 or may terminate proximate front of seat base. Comfort layer 212C further extends laterally between thigh support bolsters 220 provided on opposite sides of seat base 208. In some embodiments, thigh support bolsters 220 may comprise medium density foam material identical to that used to implement top layer 212B. In alternative embodiments, the foam material from which top layer 212B and thigh support bolsters 218 are constructed may have slightly different densities, or firmnesses. In still other embodiments, thigh support bolsters 220 may comprise low density foam material identical to that used to implement comfort layer 212C. In other alternative embodiments, the foam material from which comfort layer 212C and thigh support bolsters 220 are constructed may have slightly different densities, or firmnesses.

In particular embodiments, thigh support bolsters 220 are configured to extend from the rear of seat base 208 to the front of seat base. As illustrated in FIG. 2, a thickness of thigh support bolsters 220 tapers from a maximum thickness at the outer edges of seat base 208 to a minimum thickness (approximately the thickness of comfort layer 212C) at the outer edges of comfort layer. In particular embodiments, lateral support bolsters 216 and lumbar support 214 interoperate to functionally cradle a passenger seated in seat portion 202. Thigh support bolsters 220 function to support outer thigh areas of a passenger.

Layers 210A-210C, 212A-212C, may be supported on a seat base made of metal or other appropriate material for implementing a rotorcraft passenger seat base and may be covered by material such as leather, fabric, or other material for protecting exposed surfaces of layers.

Headrest portion 204 may comprise low density foam material arranged in a slightly concave shape to comfortably cradle the back of a passenger's head. In alternative embodiments, head rest portion 204 may comprise medium density foam material. Headrest portion 204 is configured to include a vertical portion 222 and a horizontal portion 224 extending rearward from the bottom edge of the vertical portion for supporting a headset disposed on a top side of the horizontal portion, or platform. In particular embodiments, platform may be configured to include receptacles, protrusions, or other features for providing additional restraint for a headset supported thereon. As such, headrest portion 204 functions as a headrest storage assembly. A thickness of foam material comprising vertical portion 222, or support portion, may be of a thickness appropriate for providing comfortable support the head of a passenger seated in seat portion 202. In some embodiments, the thickness of the foam material comprising the support portion is in the range of approximately 32-40 millimeters (mm). Horizontal portion 224 comprises a flange for connecting headrest portion 204 to seat portion 202, e.g., via one or more posts that may be permanently connected to a bottom side of horizontal portion 224 for insertion into one or more receptacles provided in a top of seat portion 202. A height of head rest portion 204 may be adjustable relative to top of seat portion 202.

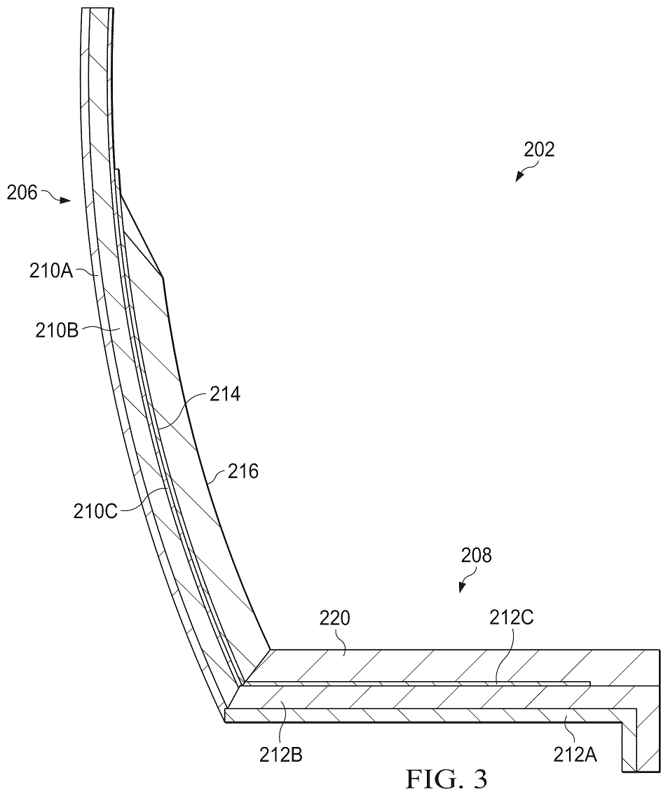

Referring now to FIG. 3, illustrated therein is a representative side cutaway view of the example passenger seat of FIG. 2 showing example relative thicknesses of layers thereof according to features of embodiments described herein. In a particular embodiment, layer 210A may have a thickness of approximately 10 millimeters (mm), layer 210B may have a thickness of approximately 20 mm, layer 210C may have a thickness of approximately 5 mm, and area 214 may have a thickness of approximately 5 mm. Layer 212A may have a thickness of approximately 15 mm, layer 212B may have a thickness of approximately 20 mm, and layer 212C may have a thickness of approximately 5 mm. In particular embodiments, a thickness (or height) of lateral support bolsters 216 along outside edges thereof may be approximately 43 mm and a width of lateral support bolsters may be approximately 64 mm. In particular embodiments, a thickness (or height) of thigh support bolsters 220 along outside edges thereof may be approximately 56 mm and a width of thigh support bolsters may be approximately 76 mm.

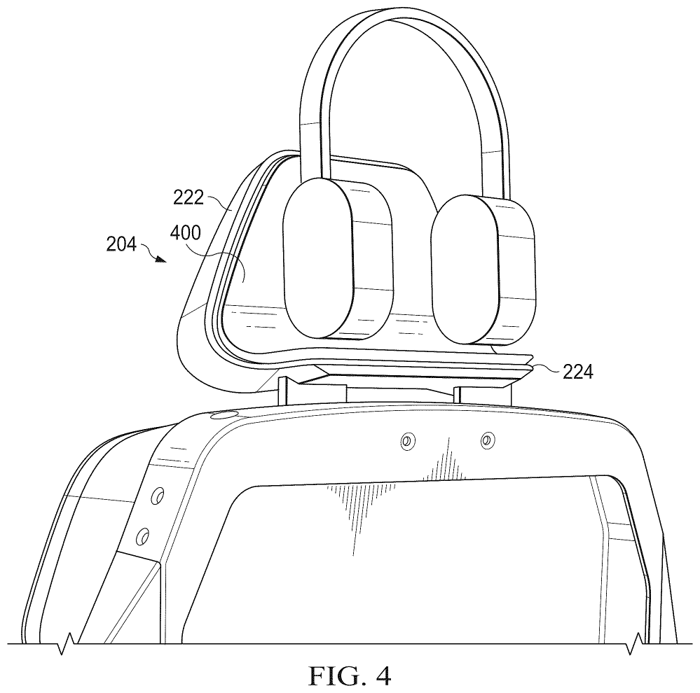

FIG. 4 illustrates a perspective view of the back side of headrest portion 204. As shown in FIG. 4, foam material comprising head rest may be supported on a base 400 constructed of metal or other appropriate material. Headrest portion 204 may be covered by material such as leather, fabric, or other material for protecting exposed surfaces of foam material comprising support portion 222.

Example 1 provides a seat assembly for a vehicle, the seat assembly including a seat portion including a seat back including a first layer including a first foam material having a first density; a second layer on the first layer and including a second foam material having a second density less than the first density; and a third layer on the second layer and including a third foam material having a third density less than the second density; and a seat base including a fourth layer including a fourth foam material having a fourth density; a fifth layer on the fourth layer and including a fifth foam material having a fifth density less than the fourth density; and a sixth layer on the fifth layer and including a sixth foam material having a sixth density less than the fifth density.

Example 2 provides the seat assembly of example 1, further including a headrest portion connected above a top edge of the seat back.

Example 3 provides the seat assembly of example 2, in which the headrest portion includes a vertical portion for supporting a head of a passenger seated in the seat and a horizontal portion connected to a rear of the vertical portion and configured to retain a headset thereon.

Example 4 provides the seat assembly of example 3, in which the vertical portion of the headrest portion comprises a cushioned front surface comprising one of the first, second, or third foam materials.

Example 5 provides the seat assembly of example 1, in which the first density is 15-20% greater than the second density and second density is 15-20% greater than the third density.

Example 6 provides the seat assembly of example 1, in which the fourth density is 15-20% greater than the fifth density and the fifth density is 15-20% greater than the sixth density.

Example 7 provides the seat assembly of example 1, in which the first foam material is identical to the fourth foam material.

Example 8 provides the seat assembly of example 1, in which the second foam material is identical to the fifth foam material.

Example 9 provides the seat assembly of example 1, in which the third foam material is identical to the sixth foam material.

Example 10 provides the seat assembly of example 1, further including thigh support bolsters on opposite sides of the seat base.

Example 11 provides the seat assembly of example 10, in which the thigh support bolsters include the fifth foam material or the sixth foam material.

Example 12 provides the seat assembly of example 10, further including a comfort layer on the sixth layer and between the thigh support bolsters.

Example 13 provides the seat assembly of example 12, in which the comfort layer includes the sixth foam material.

Example 14 provides the seat assembly of example 1, further including lateral support bolsters on opposite sides of the seat back.

Example 15 provides the seat assembly of example 14, in which the lateral support bolsters include the third foam material.

Example 16 provides the seat assembly of example 14, further including a lumbar support layer on the third layer between the lateral support bolsters.

Example 17 provides the seat assembly of example 16, in which the lumbar support layer includes the third foam material.

Example 18 provides a passenger seat for an aircraft, the passenger seat including a seat portion including a seat back and a seat base, the seat portion further including a first layer including a first foam material having a first density; a second layer including a second foam material having a second density less than the first density, in which the second layer is disposed on the first layer; and a third layer including a third foam material having a third density less than the second density, in which the third layer is disposed on the second layer; thigh support bolsters disposed along opposite sides of the seat base; a comfort layer including the third foam material disposed on the seat base between the thigh support bolsters; lateral support bolsters disposed along on opposite sides of the seat back; and a lumbar support layer including the third foam material between the lateral support bolsters; and a headrest portion connected above the seat portion, the headrest portion including a support portion including one of the first, second, and third foam materials, in which a front surface of the support portion is contoured to support a head of a passenger seated in the seat portion, the headrest portion further including a platform extending rearwardly from the support portion, the platform configured to stow a headset behind the support portion.

Example 19 provides the passenger seat of example 18, in which the second layer is thicker than the first layer and the first layer is thicker than the third layer.

Example 20 provides an aircraft including a fuselage; at least one wing connected to the fuselage; and a passenger seat within the fuselage, the passenger seat including a seat portion including a seat back and a seat base, the seat portion further including a first layer including a first foam material having a first density; a second layer including a second foam material having a second density less than the first density, in which the second layer is disposed on the first layer; and a third layer including a third foam material having a third density less than the second density, in which the third layer is disposed on the second layer; thigh support bolsters disposed along opposite sides of the seat base; a comfort layer including the third foam material disposed on the seat base between the thigh support bolsters; lateral support bolsters disposed along on opposite sides of the seat back; and a lumbar support layer including the third foam material between the lateral support bolsters; and a headrest portion connected above the seat portion, the headrest portion including a support portion including one of the first, second, and third foam materials, in which a front surface of the support portion is contoured to support a head of a passenger seated in the seat portion, the headrest portion further including a platform extending rearwardly from the support portion, the platform configured to stow a headset behind the support portion.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, RI, and an upper limit, Ru, is disclosed, any number falling within the range is specifically disclosed. In particular, the following numbers within the range are specifically disclosed: R=RI+k*(Ru−RI), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C. The terms “substantially,” “close,” “approximately,” “near,” and “about,” generally refer to being within +/−5-20% of a target value based on the context of a particular value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value based on the context of a particular value as described herein or as known in the art.

The diagrams in the FIGURES illustrate the architecture, functionality, and/or operation of possible implementations of various embodiments of the present disclosure. Although several embodiments have been illustrated and described in detail, numerous other changes, substitutions, variations, alterations, and/or modifications are possible without departing from the spirit and scope of the present disclosure, as defined by the appended claims. The particular embodiments described herein are illustrative only and may be modified and practiced in different but equivalent manners, as would be apparent to those of ordinary skill in the art having the benefit of the teachings herein. Those of ordinary skill in the art would appreciate that the present disclosure may be readily used as a basis for designing or modifying other embodiments for carrying out the same purposes and/or achieving the same advantages of the embodiments introduced herein. For example, certain embodiments may be implemented using more, less, and/or other components than those described herein. Moreover, in certain embodiments, some components may be implemented separately, consolidated into one or more integrated components, and/or omitted. Similarly, methods associated with certain embodiments may be implemented using more, less, and/or other steps than those described herein, and their steps may be performed in any suitable order.

Numerous other changes, substitutions, variations, alterations, and modifications may be ascertained to one of ordinary skill in the art and it is intended that the present disclosure encompass all such changes, substitutions, variations, alterations, and modifications as falling within the scope of the appended claims.

One or more advantages mentioned herein do not in any way suggest that any one of the embodiments described herein necessarily provides all the described advantages or that all the embodiments of the present disclosure necessarily provide any one of the described advantages. Note that in this specification, references to various features included in “one embodiment”, “example embodiment”, “an embodiment”, “another embodiment”, “certain embodiments”, “some embodiments”, “various embodiments”, “other embodiments”, “alternative embodiment”, and the like are intended to mean that any such features are included in one or more embodiments of the present disclosure but may or may not necessarily be combined in the same embodiments.

As used herein, unless expressly stated to the contrary, use of the phrase “at least one of,” “one or more of” and “and/or” are open ended expressions that are both conjunctive and disjunctive in operation for any combination of named elements, conditions, or activities. For example, each of the expressions “at least one of X, Y and Z”, “at least one of X, Y or Z”, “one or more of X, Y and Z”, “one or more of X, Y or Z” and “A, B and/or C” can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z. Additionally, unless expressly stated to the contrary, the terms “first,” “second,” “third,” etc., are intended to distinguish the particular nouns (e.g., blade, rotor, element, device, condition, module, activity, operation, etc.) they modify. Unless expressly stated to the contrary, the use of these terms is not intended to indicate any type of order, rank, importance, temporal sequence, or hierarchy of the modified noun. For example, “first X” and “second X” are intended to designate two X elements that are not necessarily limited by any order, rank, importance, temporal sequence, or hierarchy of the two elements. As referred to herein, “at least one of,” “one or more of,” and the like can be represented using the “(s)” nomenclature (e.g., one or more element(s)).

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A seat assembly for a vehicle, the seat assembly comprising:
a seat portion comprising:
a seat back comprising:
a first layer comprising a first foam material having a first density;
a second layer on the first layer and comprising a second foam material having a second density less than the first density; and
a third layer on the second layer and comprising a third foam material having a third density less than the second density; and
a seat base comprising:
a fourth layer comprising a fourth foam material having a fourth density;
a fifth layer on the fourth layer and comprising a fifth foam material having a fifth density less than the fourth density; and
a sixth layer on the fifth layer and comprising a sixth foam material having a sixth density less than the fifth density.

2. The seat assembly of claim 1, further comprising a headrest portion connected above a top edge of the seat back.

3. The seat assembly of claim 2, wherein the headrest portion comprises a vertical portion for supporting a head of a passenger seated in the seat and a horizontal portion connected to a rear of the vertical portion and configured to retain a headset thereon.

4. The seat assembly of claim 3, wherein the vertical portion of the headrest portion comprises a cushioned front surface comprising one of the first, second, or third foam materials.

5. The seat assembly of claim 1, wherein the first density is 15-20% greater than the second density and second density is 15-20% greater than the third density.

6. The seat assembly of claim 1, wherein the fourth density is 15-20% greater than the fifth density and the fifth density is 15-20% greater than the sixth density.

7. The seat assembly of claim 1, wherein the first foam material is identical to the fourth foam material.

8. The seat assembly of claim 1, wherein the second foam material is identical to the fifth foam material.

9. The seat assembly of claim 1, wherein the third foam material is identical to the sixth foam material.

10. The seat assembly of claim 1, further comprising thigh support bolsters on opposite sides of the seat base.

11. The seat assembly of claim 10, wherein the thigh support bolsters comprise the fifth foam material or the sixth foam material.

12. The seat assembly of claim 10, further comprising a comfort layer on the sixth layer and between the thigh support bolsters.

13. The seat assembly of claim 12, wherein the comfort layer comprises the sixth foam material.

14. The seat assembly of claim 1, further comprising lateral support bolsters on opposite sides of the seat back.

15. The seat assembly of claim 14, wherein the lateral support bolsters comprise the third foam material.

16. The seat assembly of claim 14, further comprising a lumbar support layer on the third layer between the lateral support bolsters.

17. The seat assembly of claim 16, wherein the lumbar support layer comprises the third foam material.

18. A passenger seat for an aircraft, the passenger seat comprising:
a seat portion comprising a seat back and a seat base, the seat portion further comprising:
a first layer comprising a first foam material having a first density;
a second layer comprising a second foam material having a second density less than the first density, wherein the second layer is disposed on the first layer; and
a third layer comprising a third foam material having a third density less than the second density, wherein the third layer is disposed on the second layer;
thigh support bolsters disposed along opposite sides of the seat base;
a comfort layer comprising the third foam material disposed on the seat base between the thigh support bolsters;
lateral support bolsters disposed along on opposite sides of the seat back; and
a lumbar support layer comprising the third foam material between the lateral support bolsters; and
a headrest portion connected above the seat portion, the headrest portion comprising a support portion comprising one of the first, second, and third foam materials, wherein a front surface of the support portion is contoured to support a head of a passenger seated in the seat portion, the headrest portion further comprising a platform extending rearwardly from the support portion, the platform configured to stow a headset behind the support portion.

19. The passenger seat of claim 18, wherein the second layer is thicker than the first layer and the first layer is thicker than the third layer.

20. An aircraft comprising:
a fuselage;
at least one wing connected to the fuselage; and
a passenger seat within the fuselage, the passenger seat comprising:
a seat portion comprising a seat back and a seat base, the seat portion further comprising:
a first layer comprising a first foam material having a first density;
a second layer comprising a second foam material having a second density less than the first density, wherein the second layer is disposed on the first layer; and
a third layer comprising a third foam material having a third density less than the second density, wherein the third layer is disposed on the second layer;
thigh support bolsters disposed along opposite sides of the seat base;
a comfort layer comprising the third foam material disposed on the seat base between the thigh support bolsters;
lateral support bolsters disposed along on opposite sides of the seat back; and
a lumbar support layer comprising the third foam material between the lateral support bolsters; and
a headrest portion connected above the seat portion, the headrest portion comprising a support portion comprising one of the first, second, and third foam materials, wherein a front surface of the support portion is contoured to support a head of a passenger seated in the seat portion, the headrest portion further comprising a platform extending rearwardly from the support portion, the platform configured to stow a headset behind the support portion.
